(19) United States
(12) Patent Application Publication
(10) Pub. No.: US 2026/0363369 A1
(43) Pub. Date: Nov. 19, 2026

(54) Protective Coverall having Resilient Waistband of Protective Fabric

(71) Applicant: DUPONT SAFETY & CONSTRUCTION, INC., Wilmington, DE (US)

(72) Inventors: Colin McLachlan, Sumter, SC (US); Judith Lee Denny-Lybbert, West Columbia, SC (US); Heather J. Figlioli, Camden, SC (US)

(21) Appl. No.: 19/252,611

(22) Filed: Jun. 27, 2025

Related U.S. Application Data
(60) Provisional application No. 63/665,831, filed on Jun. 28, 2024.

(51) Int. Cl. A41D 13/02; A41D 31/18; A41F 9/00

(52) U.S. Cl. CPC A41D 13/02; A41D 31/18; A41F 9/00; A41D 2200/20; A41D 2400/44

(57) ABSTRACT

A protective coverall comprising a protective fabric, the protective coverall comprising a circumferential waist area having a circumference, and comprising a circumferential resilient waistband having a top edge and a bottom edge, and a width of 3 to 5 inches, wherein the circumferential resilient waistband further comprises a waist array of at least 3 parallel continuous elastic threads or strands, or at least 3 parallel continuous elastic strips, the waist array being circumferential to the cylindrical waist area of the coverall and is part of the cylindrical wall of the cylindrically-shaped portion of body portion of the coverall, the parallel continuous elastic threads being spaced apart from each other a distance of 0.125 to 2 inches, and the bottom edge of the circumferential resilient waistband being vertically located 13 inches to 18 inches from the nadir of the crotch area of the coverall, the coverall further comprising a center back resilient center band.

### BACKGROUND OF THE INVENTION

This invention relates to a disposable protective coverall, preferably a single or limited use coverall, that is suitable for use in hazardous environments. The coverall has features that are believed to improve the fit of the coverall to a wearer, and additionally better fit a wide range of body types. While it is believed the protective coverall is particularly useful in biohazard protection, it can find use in any chemical or other application where workers need to be covered and/or protected, or in clean room environments.

Each of U.S. Pat. Nos. 10,889,066 and 11,254,066 discloses an apparatus for fabricating elastic nonwoven materials, and those elastic nonwoven materials are utilized in a variety of articles including personal care articles (e.g., adult briefs, baby diapers, child/adult pull-on pants, contour fit hygiene products, etc.) and medical garments (e.g., masks, caps, gowns, footwear, etc.).

Workers need protective coveralls to work in hazardous environments; however, protective coveralls are sized for certain standard body types. Any workers having body types that do not match those standard body types can frequently experience fit, comfort, and mobility issues. In some cases, the poor fit can cause the coverall to rip during use, potentially exposing a worker to harmful chemicals or other hazards. While unisex sizing has been touted as a possible solution, current offerings are still lacking.

Recognizing that no two persons share the same anatomy relative to height, body shape, body circumferences, or configuration, it is desirable for a protective coverall to fit a broader set of anatomical measurements with a smaller set of coverall sizes and that the fit within a coverall size be more equitable, offering a non-gendered fit that fits a wider range of heights and weights of wearers, and a coverall that also maintains proper positioning of the protective coverall on the wearer's body during work and other activities. Therefore, any improvement in coverall design that can improve the initial fit, and maintain that fit during use of a protective coverall to diverse body types would be welcomed.

### BRIEF SUMMARY OF THE INVENTION

This invention relates to a protective coverall comprising a protective fabric, the protective coverall having a body portion configured for covering at least a portion of a torso of a person when the protective coverall is worn by the person;
the body portion having at least one torso opening configured for donning the protective coverall and a neck opening configured for receiving a head and neck of the person, the body portion further having a plurality of openings; each of the plurality of openings including an opening ending in a sleeve configured for receiving a body part of the person when the person wears the protective coverall, each of the sleeves further having an opening ending in a resilient cuff,
wherein the protective coverall has a shoulder area and a crotch area, with the body portion comprising a cylindrically-shaped portion of protective fabric extending from the apex of the shoulder area to the nadir of the crotch area, and
wherein said cylindrically-shaped portion further comprises a circumferential waist area having a circumference, the waist area comprising a circumferential resilient waistband, the circumferential resilient waistband having a top edge and a bottom edge, and a width of 3 to 5 inches,
the circumferential resilient waistband further comprising a waist array of at least 3 parallel continuous elastic threads or strands that are circumferential to the cylindrically-shaped portion, the parallel continuous elastic threads being spaced apart from each other a distance of 0.125 to 2 inches, the bottom edge of the circumferential resilient waistband being vertically located 13 inches to 18 inches from the nadir of the crotch area; and
wherein the coverall comprises a front side and a back side, and the back side of the coverall further comprises a resilient centering band, said resilient centering band being vertically oriented on the body portion on the back side of the coverall, said resilient centering band extending from a neckline of the coverall to the top edge of the circumferential resilient waistband.

This invention also relates to a protective coverall comprising a protective fabric, the protective coverall having a body portion configured for covering at least a portion of a torso of a person when the protective coverall is worn by the person;
the body portion having at least one torso opening configured for donning the protective coverall and a neck opening configured for receiving a head and neck of the person,
the body portion further having a plurality of openings; each of the plurality of openings including an opening ending in a sleeve configured for receiving a body part of the person when the person wears the protective coverall, each of the sleeves further having an opening ending in a resilient cuff,
wherein the protective coverall has a shoulder area and a crotch area, with the body portion comprising a cylindrically-shaped portion of protective fabric extending from the apex of the shoulder area to the nadir of the crotch area, and
wherein said cylindrically-shaped portion further comprises a circumferential waist area having a circumference, the waist area comprising a circumferential resilient waistband, the circumferential resilient waistband having a top edge and a bottom edge, and a width of 3 to 5 inches,
the circumferential resilient waistband further comprising a waist array of at least 3 parallel continuous elastic strips that are circumferential to the cylindrically-shaped portion, the parallel continuous elastic strips being spaced apart from each other a distance of 0.125 to 2 inches, the bottom edge of the circumferential resilient waistband being vertically located 13 inches to 18 inches from the nadir of the crotch area; and
wherein the coverall comprises a front side and a back side, and the back side of the coverall further comprises a resilient centering band, said resilient centering band being vertically oriented on the body portion of the back side of the coverall, said resilient centering band extending from a neckline of the coverall to the top edge of the circumferential resilient waistband.

### BRIEF DESCRIPTION OF THE DRAWINGS

FIGS. 1a & 1b are front and back illustrations, respectively, of a protective coverall having a circumferential resilient waistband encircling the waist.

FIGS. 2a & 2b are front and back illustrations, respectively, of a preferred protective coverall having a circumferential resilient waistband encircling the waist, a resilient centering band being vertically oriented on the body portion of the back side of the coverall, and a plurality of sleeves, including a hood sleeve, each sleeve ending in a resilient cuff.

FIG. 3 is an illustration of a perspective view of the circumferential resilient waistband fabric. This is a view of the fully extended fabric, as if the elastic threads were stretched or extended under tension.

FIG. 4 is an illustration of a top view of the circumferential resilient waistband fabric showing the plurality of continuous circumferential elastic threads being held between two layers of protective fabric, the continuous circumferential elastic threads present in a parallel array and held by transverse weld lines that are transverse to the parallel array of elastic threads. This is a view of the fully extended fabric, as if the elastic threads were stretched or extended under tension.

FIGS. 5a & 5b are illustrations of idealized cross sections of the extended circumferential resilient waistband fabric, with FIG. 5a illustrating the unbonded areas in the between weld lines and FIG. 5b illustrating the bonded areas caused by those transverse weld lines.

FIG. 6 is a detail illustration of one type of sewn seam between the circumferential resilient waistband fabric and the protective apparel fabric of the body portion of the protective coverall, which can be used to attach the inner face of the protective fabric in direct contact with the inner face of the circumferential resilient waistband fabric.

FIG. 7a & &b are illustrations of the structure of a circumferential elastic waistband comprising, from the top edge to the bottom edge, a parallel array of at least 3 circumferential elastic strips with intervening circumferential panel strips of coverall fabric, each of the circumferential elastic strips being seamed to at least one circumferential panel strip of coverall fabric.

FIGS. 8a & 8b are front and back illustrations, respectively, showing the improved fit of a preferred protective coverall having a circumferential resilient waistband encircling the waist, a resilient centering band being vertically oriented on the body portion of the back side of the coverall, and a plurality of sleeves, including a hood sleeve, each sleeve ending in a resilient cuff.

### DETAILED DESCRIPTION OF THE INVENTION

The inventive protective coverall has new combination of fit and comfort features that allows a protective coverall of one size to better fit workers of different genders and body types and sizes. Since each size of the coverall comfortably fits a larger range of body dimensions, fewer coverall sizes are needed. Additionally, the improved fit and comfort features of the protective coverall improve the positioning of the protective coverall on the wear's body.

Traditionally, protective coveralls have placed elastic waistbands at a low waist location similar to the location of the belt or waist on male jeans. The present invention raises the location of the coverall waistband to a higher waist area above the navel of the wearer. Additionally, the new combination of fit and comfort features is provided by the proper location of circumferential and vertical elastics in the coverall, and the calibration of elastic retraction and elastic force to maintain the appropriate position of the protective coverall on the wearer's upper body.

Specifically, the protective coverall comprises a circumferential waist area having a circumference, the circumferential waist area comprising a circumferential resilient waistband. The term “resilient” as used herein has the common meaning of a material that will spring back or recoil to its original shape after extended or stretched. A resilient waistband is one that can be extended or stretched and will endeavor to spring back to its original relaxed state.

The circumferential resilient waistband has a top edge and a bottom edge, and a width of 3 to 5 inches. The circumferential resilient waistband is made resilient by comprising a waist array of at least three parallel continuous elastic threads or strands, the parallel continuous elastic threads being spaced apart from each other a distance of 0.125 to 2 inches. As used herein, a continuous elastic thread or strand is an individual continuous elastic filament, an elastic yarn, or a coalesced grouping of continuous elastic filaments. Additionally, the bottom edge of the circumferential resilient waistband is vertically located on the coverall 13 inches to 18 inches from the nadir of the crotch area of the coverall.

The protective coverall can have the following general structure. The protective coverall can comprise a protective fabric, the protective fabric comprising an outer face and an inner face, wherein the inner face has an antistatic treatment. The protective coverall can have a body portion configured for covering at least a portion of a torso of a person when the protective coverall is worn by the person; the body portion having at least one torso opening configured for donning the protective coverall and a neck opening configured for receiving a head and neck of the person. The body portion can further have a plurality of openings; the plurality of openings including a first opening ending in a first arm sleeve configured for receiving a portion of a right arm of the person when the person wears the protective coverall, and a second opening ending in a second arm sleeve configured for receiving a portion of a left arm of the person when the person wears the protective coverall. Each of the first and second arm sleeves can further have an opening configured for receiving a wrist and hand of the person, with each arm sleeve having a proximate end at the body portion and a distal end at the opening configured for receiving a wrist and hand. The plurality of openings can further include a third opening ending in a first leg sleeve configured for receiving a portion of a right leg of the person when the person wears the protective coverall, and a fourth opening ending in a second leg sleeve configured for receiving a portion of a left leg of the person when the person wears the protective coverall. Each of the first and second leg sleeves can further have an opening configured for receiving an ankle and foot of the person, with each leg sleeve having a proximate end at the body portion and a distal end at the opening configured for receiving an ankle and foot. The body portion, each of the arm sleeves, and each of the leg sleeves can have an interior surface configured for facing the person when the person wears the protective coverall, and an exterior surface; and the inner face of the protective fabric can form the said interior surface of the body portion, each of the arm sleeves, and each of the leg sleeves, and the outer face of the protective fabric can form the said exterior surface of the body portion, each of the arm sleeves, and each of the leg sleeves. The distal end of each arm sleeve and each leg sleeve can comprise a resilient cuff, said resilient cuff having a proximate end and a distal end, with the proximate end of each cuff attached to the distal end of each respective arm sleeve and leg sleeve, and each resilient cuff can further have a cuff interior surface configured for facing the person, and a cuff exterior surface.

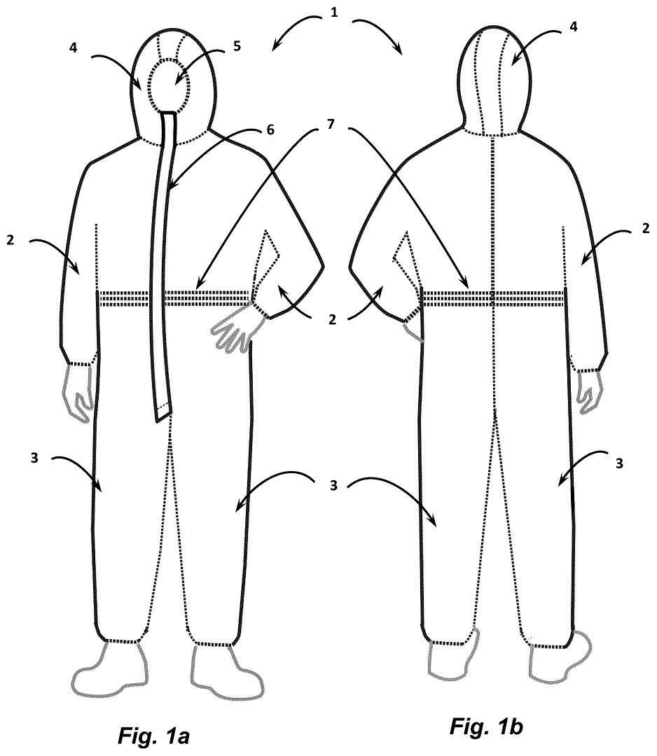

FIGS. 1a & 1b are front and back illustrations, respectively, of a protective coverall having a circumferential resilient waistband 7 encircling the waist. The coverall 1 has two arm sleeves 2 and two pants sleeves 3, and is also provided with a hood, which is considered herein to be a “hood sleeve” 4 as this is simply an additional sleeve for the head of the wearer. The hood sleeve is configured for receiving the head of a person when the person wears the protective coverall, with said hood sleeve ending in and opening 5 for the face, which can be sized to fit a respirator worn by the person. The coverall is further provided with a visible flap 6 covering a vertical fastener (not shown) on the front of the coverall.

As used herein, the orientation of coverall features is considered to be as if the coverall was being worn on a person. For example, a vertically oriented feature is considered to be oriented parallel to a vertical line drawn from the wearer's feet to the top of a person's head. A horizontally oriented feature is considered to be oriented perpendicular to a vertically oriented feature; specifically, a horizontally oriented feature is considered to be oriented parallel to a horizontal line drawn from one coverall armpit to the other or from one of the wearer's armpits to the other. For example, the zippered enclosure and front covering flap of the coverall features in FIG. 1a are vertically oriented on the coverall, while the circumferential resilient waistband is horizontally oriented on the coverall.

By circumferential resilient waistband, it is meant a resilient horizontal band that encircles the circumference of the waist area of the coverall. It is understood that the circumferential resilient waistband can fully encircle the waist area; or the circumferential resilient waistband can extend from one side of a vertically oriented fastener such as a zipper for closing the coverall, around the waist area of the coverall to the opposing side of the fastener, and still be said to encircle the circumference of the waist area.

As described herein, the body portion of the coverall comprises a cylindrically-shaped portion of protective fabric extending from the apex of the shoulder area to the nadir of the crotch area. It is understood the body portion of the coverall is configured to enclose the torso of the wearer with protective fabric (with the exceptions for openings in the body portion for sleeves, etc.) and this cylindrically-shaped portion is simply the vertically oriented portions of fabric of the body portion. Further, the apex of the shoulder area is considered the tops of the shoulders of the coverall when being worn. Likewise, the nadir of the crotch area is considered to be the lowest horizontal point on a vertical line drawn through the center of the coverall; this is typically at the meeting point of the two leg sleeves.

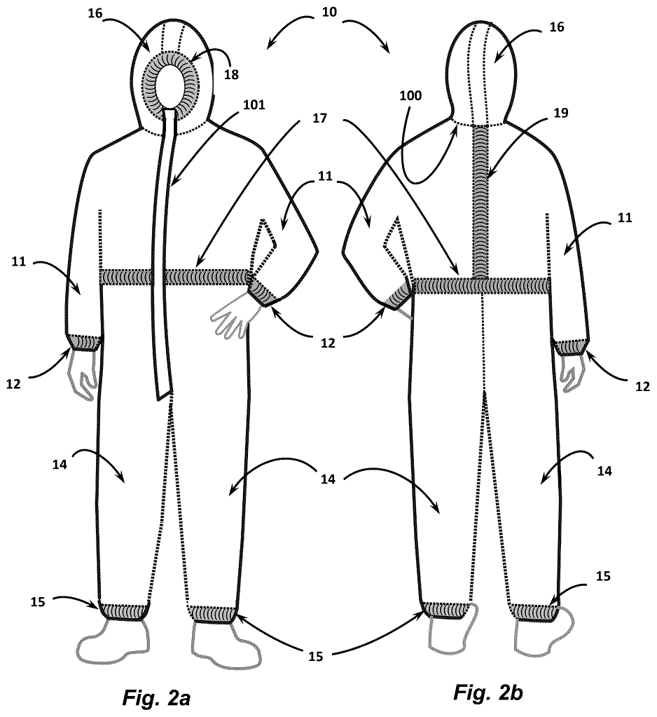

FIGS. 2a & 2b are front and back illustrations, respectively, of a preferred embodiment of a protective coverall having a circumferential resilient waistband 17 encircling the waist. This coverall 10 has two arm sleeves 11 having resilient cuffs 12 and two pants sleeves 14 having resilient cuffs 15 and is also provided with a hood sleeve 16. The hood sleeve is configured for receiving the head of a person when the person wears the protective coverall, and in this embodiment the hood sleeve ends in a resilient cuff 18, which can be sized to fit a respirator worn by the person. This version of the coverall also comprises a resilient centering band 19 on the back side of the coverall.

The resilient centering band is vertically oriented on the body portion of the back side of the coverall, said resilient centering band extending from a neckline of the coverall to the top edge of the circumferential resilient waistband. As used herein, the neckline of the coverall is considered to be the location at the neck represented by the seam 100 that attaches the hood sleeve to the coverall body portion. Alternatively, if no hood sleeve is present but the coverall has a collar, the neckline of the coverall is considered to be the location at the neck represented by the seam at the neck that attaches the collar to the coverall body portion. Likewise, if no collar or hood sleeve is present, the neckline is the actual neckline of the collarless or hoodless coverall. The coverall is further provided with a visible flap 101 covering a vertical fastener (not shown) on the front of the coverall.

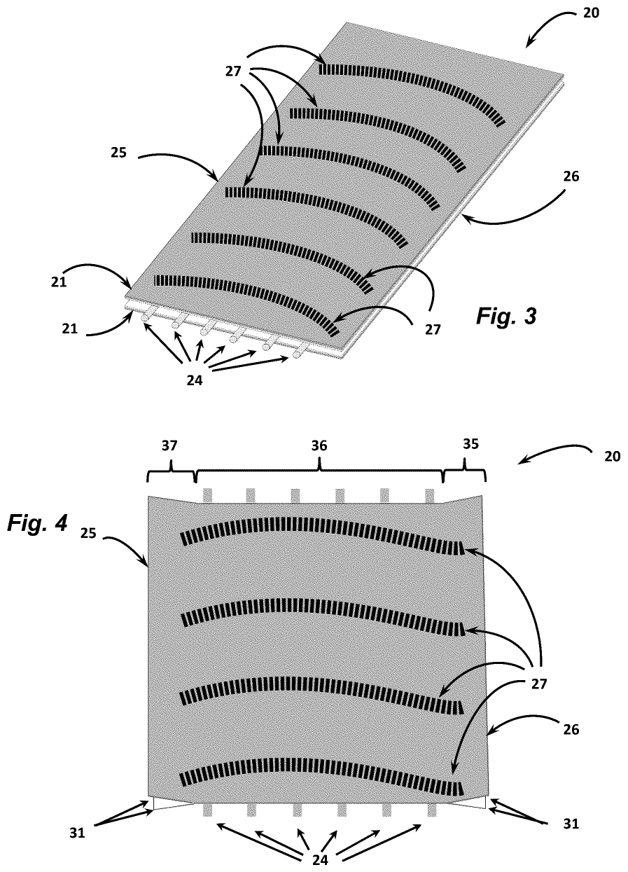

FIG. 3 is an illustration of a perspective view of the circumferential resilient waistband 20 construction. This is a view of the extended resilient waistband, as if the fabric with the elastic threads was stretched or extended under tension. The resilient waistband comprises two layers 21 of the protective fabric, with a plurality of continuous circumferential elastic threads 24 being held between the layers. In typical use, the circumferential resilient waistband has a top edge 25 and a bottom edge 26. Each of the top and bottom edges of the circumferential resilient waistband are then sewn or otherwise attached to the coverall fabric of the coverall body portion on either side of the waistband. That is, the top edge of the waistband is sewn to the upper or top portion of the body portion and the bottom edge of the waistband is sewn to the lower or bottom portion of the body portion. Also shown are a plurality of transverse weld lines 27 that are transverse to the parallel array of spaced-apart elastic threads. As used herein, “spaced-apart” means the individual threads or strands are preferably not elastically connected to one another; in other words, a woven strip of elastic is not considered to comprise an array of spaced-apart threads as there are weft or fill yarns elastically connecting any array of warp yarns. Preferably the waistband is positioned on the coverall such that these transverse weld lines are generally vertically oriented on the coverall. In some embodiments, the circumferential resilient waistband has a width, from the top edge to the bottom edge, of 3 to 5 inches.

FIG. 4 is an illustration of a top view of the circumferential resilient waistband 20 showing the free ends 31 of the two layers 21 of protective fabric at the top edge 25 and a bottom edge 26 of the circumferential resilient waistband prior to being attached or seamed to the coverall fabric on the coverall body portion on either side of the waistband. This again is a view of the extended circumferential resilient waistband, as if the fabric with elastic threads was stretched or extended under tension. The plurality of continuous circumferential elastic threads 24 are held between the layers 21 of protective fabric, the continuous circumferential elastic threads present in a parallel array 36 and held by transverse weld lines 27 that are weld points or lines that are generally parallel and orthogonal to the parallel array of elastic threads. The weld points need not be strictly orthogonal but should simply traverse across the array of elastic threads in some manner. For example, the weld points or lines can be curved with the general nature of the curve begin across the parallel array of elastic threads.

The circumferential resilient waistband is made by joining the array ends of the circumferential resilient waistband fabric together to form a circular structure that will encircle the torso (the waist) of the body. In this fashion the parallel array can expand and form a cylinder-like circumferential resilient grip to the waist of the body, with the parallel array of elastic threads being present in the cylindrical wall of the cylindrically-shaped portion of body portion of the coverall. Each individual thread or strand, therefore, provides a separate circumferential gripping contact point with the encircled waist of the wearer, providing multiple spaced-apart points of circumferential contact vertically on the wearer.

While in some embodiments, the plurality of continuous circumferential elastic threads is present in the circumferential resilient waistband as a parallel array spaced-apart elastic threads, in some preferred embodiments the circumferential resilient waistband contains a parallel array of at least 3 and preferably 3 to 20 circumferential threads spaced apart from each other a distance of 0.125 to 2 inches. In some embodiments the parallel array has 4 or more circumferential threads spaced apart from each other, and in some embodiments the parallel array can have as many as 7 or 10 circumferential threads spaced apart from each other. Further, as shown in FIG. 4, in one embodiment, the circumferential resilient waistband comprises a first seam allowance area 35, a parallel array of spaced-apart elastic threads area 36, and a second seam allowance area 37.

Therefore, in some embodiments the circumferential elastic waistband comprises, from the top edge to the bottom edge, a first seam allowance area, a parallel array of spaced-apart elastic threads area, and a second seam allowance area. Each seam allowance area can be used to attach the circumferential resilient waistband to upper and lower parts of the body portion of the coverall on either side of the waist area.

In some embodiments, the plurality of continuous circumferential elastic threads is held between the first and second layers of the protective fabric by adhesive or by ultrasonic welds. Preferably, the plurality of continuous circumferential elastic threads is present in a parallel array and the threads are held between the first and second fold layers by weld lines that are transverse to the parallel array, such described herein for FIGS. 3 & 4, the weld lines being made by lines of adhesive or ultrasonic weld lines. In some embodiments, the weld lines are essentially continuous. For example, when ultrasonic welding is used, the plurality of continuous circumferential elastic threads present in a parallel array can be welded to both layers of protective fabric, and also the two layers of protective fabric can be welded together between each of the continuous circumferential elastic thread. However, continuous weld lines are not necessarily required when ultrasonic welded is used to hold the circumferential elastic threads. In some embodiments, however, particularly when adhesive is used, the non-continuous weld lines of adhesive can be preferred in that the adhesive only needs to be present at each continuous circumferential elastic thread in the parallel array to hold each thread in place. The two layers of protective fabric are not necessarily required to be fully welded to each other between each of the continuous circumferential elastic threads.

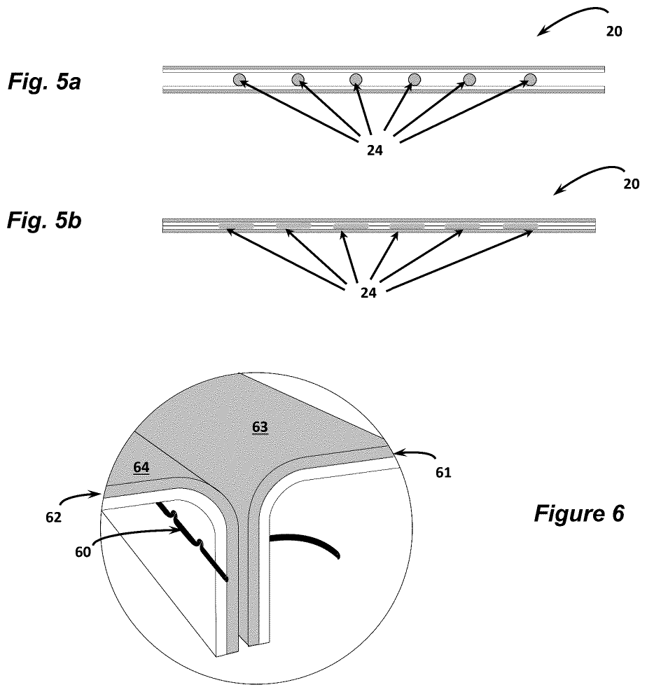

FIGS. 5a & 5b are illustrations of idealized cross sections of the extended circumferential resilient waistband 20, showing the parallel array of the plurality of continuous circumferential elastic threads 24. FIG. 5a illustrates the unbonded areas in the resilient waistband between weld lines and FIG. 5b illustrates the bonded areas caused by those transverse weld lines. An extreme compression of the elastic threads is shown in FIG. 5b simply for illustration that the layers of protective fabric and elastic threads are bonded together. Some compression would be normal if the welding was done by an ultrasonic anvil, which would compress the layers of protective fabric and the elastic threads during bonding; if an adhesive is used for the weld lines, then any compression would be less.

For applications wherein workers may work in potentially flammable environments, it is desirable for the coverall to have some method of preventing an antistatic discharge. Therefore, to improve electrostatic dissipation (ESD) performance, the protective coverall can comprise a protective fabric that has antistatic treatment to prevent the buildup of electrostatic charge, and some protective fabrics comprise an outer face and an inner face, wherein the inner face or the outer face having an antistatic treatment. In some situations, it is desirable for the buildup of electrostatic charge be avoided by providing a continuous conductive path from all parts of the coverall to the soles of the feet of wearer of the coverall to electrically ground the worker. Typical circumferential elastic waistbands are generally made from a non-conductive elastic material, and their use can impact this desired continuous conductive (or ESD) path.

Therefore, in some embodiments, the protective coverall comprises a protective fabric that has antistatic treatment to prevent the buildup of electrostatic charge, and further the circumferential resilient waistband is sewn or attached in the coverall to provide this continuous ESD path. In those situations where only one of the sides or faces of the protective fabric has an antistatic treatment, the circumferential resilient waistband is constructed and attached such a continuous ESD path across the waistband is present.

The circumferential resilient waistband can be attached or sewn in the coverall such that the waistband exterior surface faces the environment, and the inner face of the waistband interior surface faces the person. Further, it is typically desirable for the outer surface of the circumferential resilient waistband to be similar to the outer face of the protective fabric for aesthetic reasons, to match the look of the coverall.

If the protective fabric of the coverall comprises an outer face and an inner face, with the inner face having an antistatic treatment; then in the circumferential resilient waistband the plurality of continuous circumferential elastic threads can be held in place between two layers of protective fabric, with the two layers of protective fabric oriented to provide a continuous ESD path on the inner face of the waistband interior surface to match the continuous ESD path on the inner face of the coverall.

Therefore, when each layer of the protective fabric comprises an outer face and an inner face, with the inner face having an antistatic treatment, the circumferential resilient waistband can be constructed such that waistband exterior surface facing the environment is the outer face of the first exterior layer of protective fabric, and the waistband interior surface facing the person is the inner face of the second interior layer of protective fabric. This provides an antistatic-treated waistband interior surface, and a waistband exterior surface that matches the outer face of the coverall. In this circumferential resilient waistband, the continuous circumferential elastic threads are only in contact with the inner face of the first exterior layer of protective fabric and the outer face of the second interior layer of protective fabric. The waistband is then sewn or attached into the coverall such that the outer face of the first exterior layer of protective fabric faces the environment, and the inner face of the second interior layer of protective fabric of the waistband faces the person, meaning the antistatic-treated inner face of the second interior layer of protective fabric faces the person.

For ESD or antistatic continuity the waistband is attached to the coverall fabric on either side of the waistband such that the antistatic-treated inner faces of those coverall fabrics are in contact with the inner face of the second interior layer of protective fabric that forms the waistband interior surface.

FIG. 6 is a detail illustration of one type of sewn seam 60 between the circumferential resilient waistband 61 and the coverall fabric 62, which can be used to attach the inner face 63 of the second interior layer of protective fabric, that forms the interior surface of the circumferential resilient waistband 61, in direct contact with the inner face 64 of the coverall fabric 62.

In one embodiment, the protective coverall comprises a protective fabric, the protective coverall having a body portion configured for covering at least a portion of a torso of a person when the protective coverall is worn by the person. The body portion has at least one torso opening configured for donning the protective coverall and a neck opening configured for receiving a head and neck of the person. The body portion further has a plurality of additional openings; each of the plurality of additional openings including an opening ending in a sleeve configured for receiving a body part of the person when the person wears the protective coverall. In some embodiments, the sleeves include arm sleeves and leg sleeves. Each of the sleeves further has an opening ending in a resilient cuff.

The protective coverall further has a shoulder area and a crotch area, with the body portion comprising a cylindrically-shaped portion of protective fabric extending from the apex of the shoulder area to the nadir of the crotch area. This cylindrically-shaped portion further comprises a circumferential waist area. The circumferential waist area has a circumference measured on the cylindrically-shaped portion, and the circumferential waist area of the coverall comprises a circumferential resilient waistband. The circumferential resilient waistband has a top edge and a bottom edge, and a width measured vertically on the coverall from the top edge to the bottom edge of 3 to 5 inches. The circumferential resilient waistband further comprises a waist array of at least 3 parallel continuous elastic threads or strands that are circumferential to the cylindrically-shaped portion. The parallel continuous elastic threads are spaced apart from each other a distance of 0.125 to 2 inches. The circumferential resilient waistband is located on the coverall such that bottom edge of the circumferential resilient waistband is vertically located 13 inches to 18 inches from the nadir of the crotch area.

The crotch area is formed by the joining of the two pant sleeves to the cylindrically-shaped portion of the coverall. The vertical location of the bottom edge of horizontally-oriented circumferential resilient waistband on the coverall is a point that is 13 to 18 inches from the lowest point of the crotch in the garment, which is typically a point along the seam where the two pant sleeves meet. For avoidance of doubt, this lowest point or nadir of the crotch area can be determined by spreading the coverall flat on a surface to show the furthest extent of the cylindrically-shaped portion of the coverall at the conjunction of the two pants sleeves; and positioning the bottom edge of the circumferential resilient waistband 13 to 18 inches from that point.

In some embodiments, the protective coverall further comprises a front side and a back side, and the back side of the coverall further comprises a resilient centering band. The resilient centering band is vertically oriented on the body portion of the back side of the coverall and extends from the neckline of the coverall, as previously discussed herein, to the top edge of the circumferential resilient waistband. The resilient centering band can have the structure of the circumferential resilient waistband, comprising threads or strands of elastomeric material, or can be a one or more strips of elastic material. By strips of elastic material, it is meant strip of some length having a generally rectangular cross section having width and thickness, such as a woven strip of elastic material, or a monolithic strip of rubber or other elastomeric material.

In some embodiments, the circumferential elastic waistband has a retractive force when fully extended of 150 to 250 grams force, preferably a retractive force of 175 to 205 grams force. This retractive force can be measured using a “push-pull force gauge” to pull one end of the elastic after securing the other end of elastic. The elastic waistband is secured to a fixed point using a clamp and fully extended to its maximum point. The extended waistband is marked 150 cm from the fixed point. The waistband is allowed to relax, and then the force gauge is attached to the waistband at that 150 cm mark. The waistband is then extended to 150 cm and the force on the push-pull force gauge read. Preferably, when the waist of the garment is fully relaxed, the retraction of the elastic waist band is 60-75% of the full extension, which is the full circumference of the coverall waist area.

In some embodiments, such as disclosed in FIGS. 2a & 2b, the coverall additionally comprises various sleeves having resilient cuffs. In some embodiments, at least one resilient cuff has a proximate end at the sleeve and a distal end, and wherein the resilient cuff has a length, from the distal end to the proximate end, of 1 to 5 inches. In some preferred embodiments, at least one of the resilient cuffs comprises a fold of the protective fabric, with the protective fabric being folded upon itself to form first and second fold layers, and a plurality of continuous circumferential elastic threads is held between the first and second fold layers by adhesive or by ultrasonic welds, and the fold forms the distal end of the resilient cuff. In some particular embodiments, the at least one resilient cuff contains a parallel array of 4 to 15 continuous circumferential elastic threads spaced apart a distance of 0.125 to 1.0 inches. In some embodiments, the plurality of continuous circumferential elastic threads in the at least one resilient cuff is held between the first and second fold layers by weld lines that are transverse to the parallel array, the weld lines being made by lines of adhesive or ultrasonic weld lines. If desired, the protective coverall can further comprise an accessory sleeve for receiving an accessory worn by the person when the person wears the protective coverall, with said accessory sleeve ending in the resilient cuff.

The circumferential resilient waistband and versions of the resilient cuff can preferably be made by adhering or heat welding the plurality of continuous circumferential elastic threads to the two layers of protective fabric or the two fold layers of protective fabric while the elastic threads are held under tension. While this can be accomplished using adhesives, preferred methods include the application of heat or energy to tack bond the threads to the protective fabric, and a preferred method is the use of ultrasonic bonding. This can be achieved using an apparatus such as disclosed in U.S. Pat. No. 10,889,066 or 11,254,066 to Begrow, et al. or other ultrasonic bonding machines available in the art.

The continuous elastic threads can be filaments of an elastomeric material, the elastomeric material preferably having the ability to return to its original length rapidly after repeated stretching, even to at least twice its original length. Preferred elastic threads include polyurethane based yarns such as spandex or elastane; however, any fiber generally having stretch and recovery can be used. Suitable well-known elastomeric yarns also include the products sold under the tradenames Creora®, Dorlastan®, Lycra®, and other brand names.

The preferred continuous elastic thread is spandex elastomeric filament(s). As used herein, “spandex” (or “elastane”, used interchangeably herein) has its usual definition, that is, a manufactured fiber in which the fiber-forming substance is a long chain synthetic polymer composed of at least 85% by weight of a segmented polyurethane. Among the segmented polyurethanes of the spandex type are those described in, for example, U.S. Pat. Nos. 2,929,801; 2,929,802; 2,929,803; 2,929,804; 2,953,839; 2,957,852; 2,962,470; 2,999,839; and 3,009,901.

In some processes for making spandex elastomeric filaments, coalescing jets are used to consolidate the spandex filaments immediately after extrusion. It is also well known that dry-spun spandex filaments are tacky immediately after extrusion. The combination of bringing a group of such tacky filaments together and using a coalescing jet will produce a coalesced multifilament yarn, which is then typically coated with a silicone or other finish before winding to prevent sticking on the package. Such a coalesced grouping of filaments, which is actually a number of tiny individual filaments adhering to one another along their length, is superior in many respects to a single filament of spandex of the same linear density.

Each continuous elastic thread is preferably a continuous filament and can be present in the form of one or more individual filaments, a yarn, or one or more coalesced grouping of filaments. However, it is preferred to use only one coalesced grouping of filaments for each continuous elastic thread. Whether present as one or more individual filaments or one or more coalesced groupings of filaments, the overall linear density of the continuous elastic thread in the relaxed state is generally between 200 and 1200 dtex with the preferred linear density range being 600 to 900 dtex.

In another embodiment, the protective coverall comprises a protective fabric, the protective coverall having a body portion configured for covering at least a portion of a torso of a person when the protective coverall is worn by the person. The body portion has at least one torso opening configured for donning the protective coverall and a neck opening configured for receiving a head and neck of the person, the body portion further having a plurality of openings; each of the plurality of openings including an opening ending in a sleeve configured for receiving a body part of the person when the person wears the protective coverall, and each of the sleeves further having an opening, each opening ending in a resilient cuff. The protective coverall has a shoulder area and a crotch area, with the body portion comprising a cylindrically-shaped portion of protective fabric extending from the apex of the shoulder area to the nadir of the crotch area. The cylindrically-shaped portion further comprises a circumferential waist area having a circumference, the waist area comprising a circumferential resilient waistband, the circumferential resilient waistband having a top edge and a bottom edge, and a width of 3 to 5 inches.

In this embodiment, the circumferential resilient waistband further comprising a waist array of at least 3 parallel continuous elastic strips that are circumferential to the cylindrically-shaped portion. By elastic strips, it is meant a woven strip of elastic material, or a monolithic strip of rubber or other elastomeric material, each having some length and a generally rectangular cross section having a width and a thickness. However, each elastic strip is space apart from each other as previously defined herein; that is, they are preferably not elastically connected to one another. Preferably, the elastic strips have a width of from about 0.0625 to 0.75 inches and a thickness of about 0.008 to 0.030 inches. The parallel continuous elastic strips are spaced apart from each other in the circumferential resilient waistband a distance of 0.125 to 2 inches. Additionally, the bottom edge of the circumferential resilient waistband is vertically located 13 inches to 18 inches from the nadir of the crotch area.

In some embodiments, the circumferential elastic waistband comprises, from the top edge to the bottom edge, a parallel array of at least 3 circumferential elastic strips with intervening circumferential panel strips of coverall fabric, each of the circumferential elastic strips being seamed to at least one circumferential panel strip of coverall fabric. As used herein, the term “seamed” is meant to include sewing two things together (e.g., an elastic strip with a circumferential panel strip, or an elastic strip with the protective fabric of the body portion, or both) with threads, or attaching two things together by ultrasonic welding, or by attaching two things together by some other method.

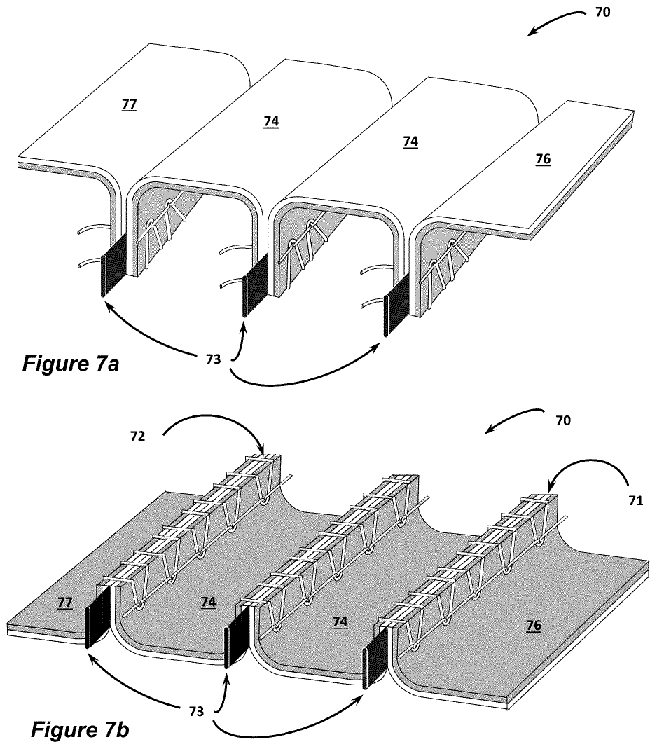

FIGS. 7a & 7b are illustrations of exterior and interior views, respectively, of the structure of a circumferential elastic waistband 70 comprising, from the top edge 71 to the bottom edge 72 (shown best in the interior view of FIG. 7b) a parallel array of at least 3 circumferential elastic strips 73 with two intervening circumferential panel strips 74 of coverall fabric, each of the circumferential elastic strips being seamed to at least one circumferential panel strip of coverall fabric. Shown are both sides of the structure, the structure having serge seams 75.

In some embodiments, the parallel array has at least 3 to 7 circumferential elastic strips with intervening circumferential panel strips of coverall fabric between each of the circumferential elastic strips, with each elastic strip being seamed to at least one circumferential panel strip of coverall fabric. In some embodiments, the parallel array has at least 3 or 4 circumferential elastic strips with intervening circumferential panel strips of coverall fabric between each of the circumferential elastic strips, with each elastic strip being seamed to at least one circumferential panel strip of coverall fabric.

In some embodiments, the top edge 71 of the circumferential elastic waistband is a seam between the top portion 76 of the body portion of the coverall and one of the elastic strips 73 (and including one circumferential panel strip of coverall fabric 74) and the bottom edge 72 of the circumferential elastic waistband is a seam between the bottom portion 77 of the body portion of the coverall and another of the elastic strips 73 (and including another circumferential panel strip of coverall fabric 74), as shown in FIGS. 7a & 7b.

In some embodiments, the coverall comprises a front side and a back side and the back side of the coverall further comprises a resilient centering band as previously described herein, said resilient centering band being vertically oriented on the body portion of the back side of the coverall, said resilient centering band extending from a neckline of the coverall to the top edge of the circumferential resilient waistband.

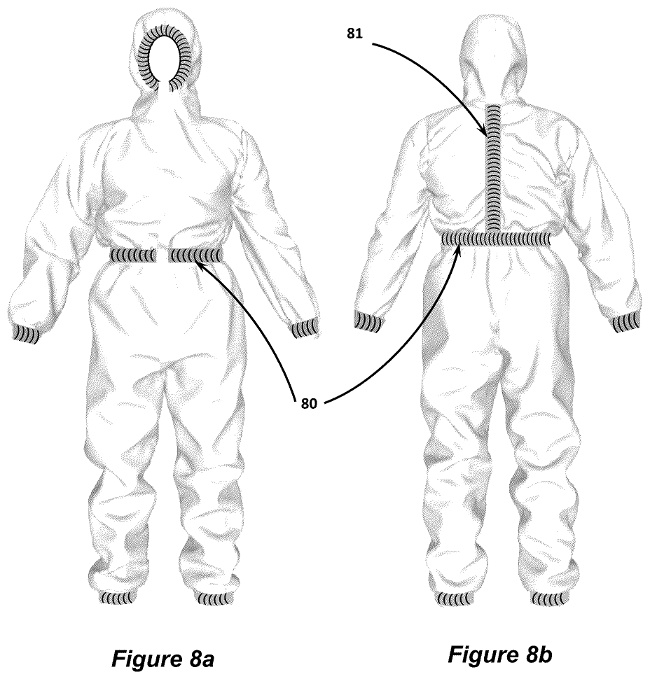

FIGS. 8a & 8b are front and back illustrations, respectively, showing the improved fit of a preferred protective coverall having a circumferential resilient waistband 80 encircling the waist (including the flap covering the fasterner), a resilient centering band 81 being vertically oriented on the body portion of the back side of the coverall, and a plurality of sleeves, including a hood sleeve, each sleeve ending in a resilient cuff. Coveralls having either of the embodiments of the circumferential resilient waistband disclosed herein, combined with any of the resilient centering bands disclosed herein, can provide this fit.

The figures illustrate how the resilient centering band 81 in the back of the coverall creates mock pleating on the back of the coverall, on both sides of the centering band, to consume and control the excess coverall material above the circumferential resilient waistband 80. Also shown is the radial effect of the combination of the circumferential resilient waistband and the resilient centering band; specifically, the pleats under the arms to the front that gathers excess coverall material on the front into natural pleats with less bulging. The combination of features provides an “instant personal fit” for each wearer. The combination of features also helps maintain the fit of the coverall on the wearer; in other words, the combination of features reduces or eliminates the tendency for the elastic components to creep or slide on the wearer during use, causing the coverall to bunch or otherwise move on the wearer. This is in addition to reducing any bulking of the coverall fabric on wearers having smaller stature.

As in the prior embodiment, the circumferential elastic waistband has a retractive force when fully extended of 150 to 250 grams force, preferably a retractive force of 175 to 205 grams force. This retractive force can be measured as previously described herein. Again, preferably, when the waist of the garment is fully relaxed, the retraction of the elastic waist band is 60-75% of the full extension, which is the full circumference of the coverall waist area.

This embodiment can also have resilient cuffs and other features as previously described for the embodiment of the circumferential elastic waistband using parallel continuous elastic threads.

In any of the embodiments the protective coverall described herein, the coverall can be a single-use garment, that is, it is used only once and then disposed of or responsibly recycled. In some embodiments, the protective coverall is a limited-use garment; that is a garment that is used, decontaminated, and re-used for a limited number of times; for example, 2 to 5 times.

The protective coverall can preferably be made from a protective apparel fabric. The term “protective apparel fabric” is meant to include a wide variety of protective garment fabrics, barrier fabrics, laminates, and films, including microporous films. The term “protective apparel fabric” also includes nonwoven and/or woven fabrics and laminates of such materials with films or multilayer films. In some embodiments, the protective fabric comprises a chemically-resistant outer layer. In some preferred embodiments the protective apparel fabric, and therefore the coverall material, is a multilayer-film-and-nonwoven laminate. In some embodiments the overall material is a nonwoven that resists penetration by liquids and/or particulates, such as a nonwoven like DuPont ™ Tyvek@ spunbonded polyethylene, or other types of nonwovens, like polyester or polypropylene, etc., spunbonded and melt-blown sheets and laminates, and other nonwoven constructions, including coated and film-laminated versions. In some embodiments the protective fabric is flame resistant or provided with a flame retardant; in some embodiments the protective fabric is flame resistant or provided with a flame retardant in addition to providing particulate, liquid, and/or chemical-or bio-challenge protection. One preferred protective coverall fabric is DuPont™ Tychem® 2000 fabrics, which feature a coated Tyvek® fabric. These fabrics provide barrier protection against a wide range of inorganic chemical and biological hazards yet are lightweight and comfortable. Other useful fabrics can include other film-laminated Tyvek® fabric styles from DuPont, including styles such as Tyvek® 800, Tychem® 2000, Tychem® 2000SFR, Tychem® 4000, Tychem® 5000, Tychem® 6000, Tychem® 6000 SFR. In addition, other useful protective coverall fabrics that protect against a wide variety of threats can be used and include but are not limited to those generally disclosed in U.S. Pat. No. 5,626,947 (Hauer et al.); U.S. Pat. No. 4,855,178 (Langley); U.S. Pat. No. 4,272,851 (Goldstein); U.S. Pat. No. 4,772,510 (McClure); U.S. Pat. No. 5,035,941 (Blackburn); U.S. Pat. No. 4,214,321 (Nuwayser); U.S. Pat. No. 4,920,575 (Bartasis); U.S. Pat. No. 5,162,148 (Boye); and U.S. Pat. No. 4,833,010 (Langley).

1. A protective coverall comprising a protective fabric,
the protective coverall having a body portion configured for covering at least a portion of a torso of a person when the protective coverall is worn by the person;
the body portion having at least one torso opening configured for donning the protective coverall and a neck opening configured for receiving a head and neck of the person,
the body portion further having a plurality of openings; each of the plurality of openings including an opening ending in a sleeve configured for receiving a body part of the person when the person wears the protective coverall, each of the sleeves further having an opening ending in a resilient cuff,
wherein the protective coverall has a shoulder area and a crotch area, with the body portion comprising a cylindrically-shaped portion of protective fabric extending from the apex of the shoulder area to the nadir of the crotch area, and
wherein said cylindrically-shaped portion further comprises a circumferential waist area having a circumference, the waist area comprising a circumferential resilient waistband, the circumferential resilient waistband having a top edge and a bottom edge, and a width of 3 to 5 inches,
the circumferential resilient waistband further comprising a waist array of at least 3 parallel continuous elastic threads or strands that are circumferential to the cylindrically-shaped portion, the parallel continuous elastic threads being spaced apart from each other a distance of 0.125 to 2 inches,
the bottom edge of the circumferential resilient waistband being vertically located 13 inches to 18 inches from the nadir of the crotch area; and
wherein the coverall comprises a front side and a back side, and the back side of the coverall further comprises a resilient centering band, said resilient centering band being vertically oriented on the body portion of the back side of the coverall, said resilient centering band extending from a neckline of the coverall to the top edge of the circumferential resilient waistband.

2. The protective coverall of claim 1, wherein when the circumferential elastic waistband is fully extended, the elastic waistband exerts a retractive force of 150 to 250 grams force.

3. The protective coverall of claim 1, wherein the circumferential elastic waistband comprises, from the top edge to the bottom edge, a first seam allowance area, a parallel array of spaced-apart elastic threads area, and a second seam allowance area.

4. The protective coverall of claim 1, wherein the sleeves include arm sleeves and leg sleeves.

5. The protective coverall of claim 1, wherein the circumferential elastic waistband comprises the plurality of continuous circumferential elastic threads is held between the first and second layers of protective fabric by adhesive or by ultrasonic welds.

6. The protective coverall of claim 5, wherein the plurality of continuous circumferential elastic threads is present in a parallel array and the continuous circumferential elastic threads are held between the first and second fold layers by weld lines that are transverse to the parallel array, the weld lines being made by lines of adhesive or ultrasonic weld lines.

7. The protective coverall of claim 1, wherein the protective coverall further comprises a hood sleeve configured for receiving the head of a person when the person wears the protective coverall, with said hood sleeve ending in the resilient cuff.

8. The protective coverall of claim 1, wherein the protective coverall further comprises an accessory sleeve for receiving an accessory worn by the person when the person wears the protective coverall, with said accessory sleeve ending in the resilient cuff.

9. The protective coverall of claim 1, wherein at least one resilient cuff has a proximate end at the sleeve and a distal end, and wherein the resilient cuff has a length, from the distal end to the proximate end, of 1 to 5 inches.

10. The protective coverall of claim 1, wherein the at least one resilient cuff comprises a fold of the protective fabric, with the protective fabric being folded upon itself to form first and second fold layers, the at least one resilient cuff further comprising a plurality of continuous circumferential elastic threads held between the first and second fold layers by adhesive or by ultrasonic welds.

11. The protective coverall of claim 10, wherein the at least one resilient cuff contains a parallel array of 4 to 15 continuous circumferential elastic threads spaced apart a distance of 0.125 to 2 inches.

12. The protective coverall of claim 10, wherein the plurality of continuous circumferential elastic threads in the at least one resilient cuff is held between the first and second fold layers by weld lines that are transverse to the parallel array, the weld lines being made by lines of adhesive or ultrasonic weld lines.

13. A protective coverall comprising a protective fabric,
the protective coverall having a body portion configured for covering at least a portion of a torso of a person when the protective coverall is worn by the person;
the body portion having at least one torso opening configured for donning the protective coverall and a neck opening configured for receiving a head and neck of the person,
the body portion further having a plurality of openings; each of the plurality of openings including an opening ending in a sleeve configured for receiving a body part of the person when the person wears the protective coverall, each of the sleeves further having an opening ending in a resilient cuff,
wherein the protective coverall has a shoulder area and a crotch area, with the body portion comprising a cylindrically-shaped portion of protective fabric extending from the apex of the shoulder area to the nadir of the crotch area, and
wherein said cylindrically-shaped portion further comprises a circumferential waist area having a circumference, the waist area comprising a circumferential resilient waistband, the circumferential resilient waistband having a top edge and a bottom edge, and a width of 3 to 5 inches,
the circumferential resilient waistband further comprising a waist array of at least 3 parallel continuous elastic strips that are circumferential to the cylindrically-shaped portion, the parallel continuous elastic strips being spaced apart from each other a distance of 0.125 to 2 inches,
the bottom edge of the circumferential resilient waistband being vertically located 13 inches to 18 inches from the nadir of the crotch area; and
wherein the coverall comprises a front side and a back side, and the back side of the coverall further comprises a resilient centering band, said resilient centering band being vertically oriented on the body portion of the back side of the coverall, said resilient centering band extending from a neckline of the coverall to the top edge of the circumferential resilient waistband.

14. The protective coverall of claim 13, wherein when the circumferential elastic waistband is fully extended, the elastic waistband exerts a retractive force of 150 to 250 grams force.

15. The protective coverall of claim 13, wherein the circumferential elastic waistband comprises, from the top edge to the bottom edge, a parallel array of the at least 3 circumferential elastic strips with intervening circumferential panel strips of coverall fabric, each of the circumferential elastic strips being seamed to at least one circumferential panel strip of coverall fabric.

16. The protective coverall of claim 13, wherein the top edge of the circumferential elastic waistband is a seam between the body portion of the coverall and one of the elastic strips and the bottom edge of the circumferential elastic waistband is a seam between the body portion of the coverall and another of the elastic strips.

17. The protective coverall of claim 13, wherein the sleeves include arm sleeves and leg sleeves.

18. The protective coverall of claim 13, wherein the protective coverall further comprises a hood sleeve configured for receiving the head of a person when the person wears the protective coverall, with said hood sleeve ending in the resilient cuff.

19. The protective coverall of claim 13, wherein the protective coverall further comprises an accessory sleeve for receiving an accessory worn by the person when the person wears the protective coverall, with said accessory sleeve ending in a resilient cuff.

20. The protective coverall of claim 13, wherein at least one resilient cuff has a proximate end at the sleeve and a distal end, and wherein the resilient cuff has a length, from the distal end to the proximate end, of 1 to 5 inches.

21. The protective coverall of claim 13, wherein the at least one resilient cuff comprises a fold of the protective fabric, with the protective fabric being folded upon itself to form first and second fold layers, the at least one resilient cuff further comprising a plurality of continuous circumferential elastic threads held between the first and second fold layers by adhesive or by ultrasonic welds.

22. The protective coverall of claim 21, wherein the at least one resilient cuff contains a parallel array of 4 to 15 continuous circumferential elastic threads spaced apart a distance of 0.125 to 2 inches.

23. The protective coverall of claim 21, wherein the plurality of continuous circumferential elastic threads in the at least one resilient cuff is held between the first and second fold layers by weld lines that are transverse to the parallel array, the weld lines being made by lines of adhesive or ultrasonic weld lines.
